(19) United States
(12) Patent Application Publication
(10) Pub. No.: US 2009/0155688 A1
(43) Pub. Date: Jun. 18, 2009

(54) ALKALINE STORAGE CELL

(75) Inventors: Takahiro ENDO, Takasaki-shi (JP); Masaru KIHARA, Moriguchi-shi (JP); Akira SAGUCHI, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/327,386

(22) Filed: Dec. 3, 2008

(30) Foreign Application Priority Data
Dec. 5, 2007 (JP) 2007-314594

(51) Int. Cl. H01M 4/38

(52) U.S. Cl. 429/218.2

(57) ABSTRACT

The negative electrode of an alkaline storage cell contains a rare earth-Mg—Ni hydrogen storage alloy. The rare earth-Mg—Ni hydrogen storage alloy has a composition expressed by a general formula: (A_{α}Ln_{1-α})_{1-β}Mg_{β}Ni_{γ-δ-ε}Al_{δ}T_{ε} wherein A represents one or more elements selected from the group consisting of Pr, Nd, Sm and Gd and including at least Sm, Ln represents at least one element selected from the group consisting of La, Ce, and the like, T represents at least one element selected from the group consisting of V, Nb, and the like, and subscripts α, β, γ, δ and ε represent numerical values which respectively satisfy 0.4≦α, 0.05<β<0.15, 3.0≦γ≦4.2, 0.15≦δ≦0.30 and 0≦ε≦0.20.

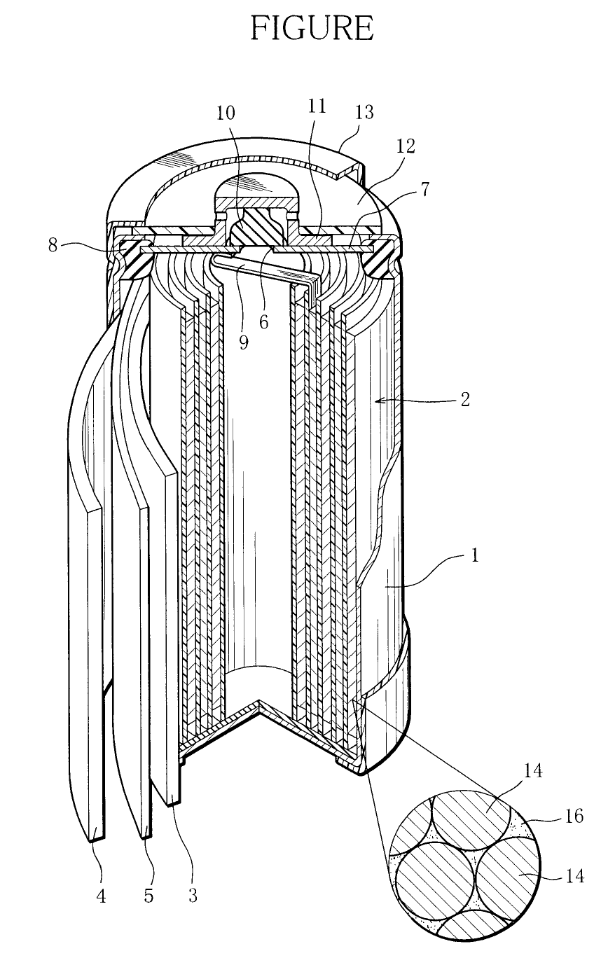

### BACKGROUND OF THE INVENTION

1. Field of the Invention

The present invention relates to an alkaline storage cell.

2. Description of the Related Art

There is an alkaline storage cell using a rare earth-Mg—Ni hydrogen storage alloy for its negative electrode. While this type of hydrogen storage alloy stores a large amount of hydrogen, the alloy has problems that it does not easily release the hydrogen stored, and that the corrosion resistance to the alkaline electrolyte is low. Due to these problems, the alkaline storage cell using the rare earth-Mg—Ni hydrogen storage alloy for the negative electrode has a poor discharge characteristic and a short cycle life.

Document 1 (Japanese Unexamined Patent Publication No. 2002-164045) discloses a rare earth-Mg—Ni hydrogen storage alloy having a composition expressed by the following general formula and conditional expression:

(R_{1-a-b}LaₐCe_{b})_{1-c}Mg_{c}Ni_{Z-X-Y-d-e}Mn_{X}Al_{Y}Co_{d}Mₑc=(−0.025/a)+f

wherein R represents at least one element selected from a group consisting of rare-earth elements including Y and Ca (excluding La and Ce), M represents at least one element selected from a group consisting of Fe, Ga, Zn, Sn, Cu, Si, B, Ti, Zr, Nb, W, Mo, V, Cr, Ta, Li, P and S, and atom ratios a, b, c, d, e, f, X, Y and Z are respectively defined as 0<a≦0.45, 0≦b≦0.2, 0.1≦c≦0.24, 0≦X≦0.1, 0.02≦Y≦0.2, 0≦d<0.5, 0≦e≦0.1, 3.2≦Z≦3.8, and 0.2≦f≦0.29.

Regarding this hydrogen storage alloy, it is thought that when the relationship c=(−0.025/a)+f is fulfilled in the general formula, hydrogen is likely to be released, which leads to an improvement of the discharge characteristic of the alkaline storage cell. Further, it is construed that this relationship suppresses precipitation of undesired crystal phases except for a Ce₂Ni₇ structure, a CeNi₃ structure and structures similar to these structures, thus preventing a decrease in the amount of hydrogen stored, which results in an improvement of the cycle-life characteristic of the alkaline storage cell.

On the other hand, in this hydrogen storage alloy, as Y, in the general formula, indicating the ratio of Al is set greater than or equal to 0.02, the oxidation thereof is suppressed, but Y is set less than or equal to 0.2 in order to suppress precipitation of undesired crystal phases.

As described above, the Document 1 discloses that the cycle-life characteristic and discharge characteristic of the alkaline storage cell are improved by limiting the composition of the rare earth-Mg—Ni hydrogen storage alloy to the range where the relationship of the conditional expression is fulfilled. However, even the use of the rare earth-Mg—Ni hydrogen storage alloy disclosed in the Document 1 does not sufficiently improve the characteristics of the alkaline storage cell.

### SUMMARY OF THE INVENTION

It is an object of the present invention to provide an alkaline storage cell of which rare earth-Mg—Ni hydrogen storage alloy has a stable crystal structure, and which has improved cycle-life and discharge characteristics.

According to one aspect of the present invention, there is provided an alkaline storage cell comprising a positive electrode, a separator, an electrolyte, and a negative electrode containing a rare earth-Mg—Ni hydrogen storage alloy, the rare earth-Mg—Ni hydrogen storage alloy having a composition expressed by a general formula:

(A_{α}Ln_{1-α})_{1-β}Mg_{β}Ni_{γ-δ-ε}Al_{δ}T_{ε}

wherein A represents one or more elements selected from the group consisting of Pr, Nd, Sm and Gd and including at least Sm, Ln represents at least one element selected from the group consisting of La, Ce, Pm, Eu, Tb, Dy, Ho, Er, Tm, Yb, Lu, Ca, Sr, Sc, Y, Ti, Zr and Hf, T represents at least one element selected from the group consisting of V, Nb, Ta, Cr, Mo, Mn, Fe, Co, Zn, Ga, Sn, In, Cu, Si, P and B, and subscripts α, β, γ, δ and ε represent numerical values which respectively satisfy 0.4≦α, 0.05<β<0.15, 3.0≦γ≦4.2, 0.15≦δ≦0.30 and 0≦ε≦0.20.

In the alkaline storage cell according to one aspect of the present invention, a large amount of Al forms a solid solution in the parent phase of the rare earth-Mg—Ni hydrogen storage alloy. This is because the rare earth-Mg—Ni hydrogen storage alloy contains Sm as its essential element, and the subscript α indicating the ratio of the content of the element represented by A is 0.40 or greater. The formation of the solid solution with a large amount of Al makes the crystal structure of the rare earth-Mg—Ni hydrogen storage alloy stable, and improves the corrosion resistance and oxidation resistance. As a result, the cycle-life characteristic of the alkaline storage cell is improved.

Further, the subscript α being 0.40 or greater raises the hydrogen equilibrium pressure of the rare earth-Mg—Ni hydrogen storage alloy. This increases the operation voltage of the alkaline storage cell, thus improving the discharge characteristic.

### BRIEF DESCRIPTION OF THE DRAWING

The present invention will become more fully understood from the detailed description given hereinbelow and the accompanying drawing which is given by way of illustration only, and thus, is not limitative of the present invention, and wherein:

the FIGURE is a partly cutaway perspective view showing one example of an alkaline storage cell according to one embodiment of the invention, where part of a negative electrode is schematically shown in enlargement within the circle.

### DETAILED DESCRIPTION

To achieve the foregoing object, the present inventors have made the invention through various studies.

The FIGURE shows a nickel-hydrogen storage cell as an alkaline storage cell according to one embodiment of the invention.

This nickel-hydrogen storage cell has a conductive exterior can 1 in the form of a bottomed cylinder, and has an electrode assembly 2 contained in the exterior can 1. The electrode assembly 2 is a lamination body having a positive electrode 3 and a negative electrode 4 rolled up with a separator 5 provided therebetween. The outer end part of the negative electrode 4 is arranged at the outermost peripheral part of the electrode assembly 2 as viewed in the rolling direction, and the negative electrode 4 is electrically connected to the inner wall surface of the exterior can 1. The exterior can 1 also contains an alkaline electrolyte not shown.

As the alkaline electrolyte, a mixture of an aqueous potassium hydroxide solution and an aqueous sodium hydroxide solution, an aqueous lithium hydroxide solution or the like, for example, can be used.

A disk-shaped sealing plate 7 with a gas release hole 6 in the center is arranged at the opening end of the exterior can 1. Specifically, a ring-shaped insulating gasket 8 is disposed between the outer peripheral edge of the sealing plate 7 and the opening end of the exterior can 1. The sealing plate 7 is fixed to the opening end of the exterior can 1 airtightly via the gasket 8 by performing a caulking work to reduce the diameter of the opening end of the exterior can 1 inward in the diametrical direction.

A positive-electrode lead 9 is arranged between the electrode assembly 2 and the sealing plate 7. One end of the positive-electrode lead 9 is electrically connected to the positive electrode 3 in the electrode assembly 2, and the other end of the positive-electrode lead 9 is connected to the inner surface of the sealing plate 7. On the outer surface of the sealing plate 7, a valve body 10 made of rubber is disposed so as to close the gas release hole 6, and further a cylindrical positive-electrode terminal 11 with a flange is mounted to cover the valve body 10.

Further, an annular pressing plate 12 is disposed at the edge of the opening end of the exterior can 1, and the cylindrical part of the positive-electrode terminal 11 projects through the center hole of the pressing plate 12. Reference numeral “13” denotes an exterior tube. The exterior tube 13 covers the outer peripheral edge of the pressing plate 12, the outer peripheral surface of the exterior can 1 and the outer peripheral edge of the bottom thereof.

The positive electrode 3 comprises a conductive positive-electrode substrate and a positive-electrode mixture supported by the positive-electrode substrate. As the positive-electrode substrate, a net-like, sponge-like, fiber-like or felt-like porous metal material plated with nickel, for example, can be used.

The positive-electrode mixture comprises powder having as a major component nickel hydroxide as a positive-electrode active material (nickel hydroxide powder), a conductive agent and a binding agent. It is preferable that the nickel hydroxide powder for use is such powder that the average valence of nickel is greater than 2 and the surface of each particle thereof is at least partly or entirely covered with a cobalt compound. The nickel hydroxide powder may be a solid solution containing cobalt and zinc.

As the conducting agent, powder of cobalt oxide, cobalt hydroxide, metal cobalt or the like, for example, can be used. As the binding agent, carboxymethylcellulose, methylcellulose, PTFE dispersion, HPC dispersion or the like, for example, can be used.

The foregoing positive electrode 3 can be made, for example, by preparing a positive-electrode slurry by mixing and kneading the nickel hydroxide powder, the conducting agent, the binding agent and water, and then rolling and cutting a positive-electrode substrate having the positive-electrode slurry applied and filled thereto after drying the positive-electrode slurry.

The negative electrode 4 comprises a conductive negative-electrode substrate and a negative-electrode mixture supported by the negative-electrode substrate. As the negative-electrode substrate, punching metal plated with nickel, for example, can be used.

As schematically shown in the circle in FIGURE, the negative-electrode mixture comprises a plurality of hydrogen storage alloy particles 14, a binding agent 16, and, as needed, a conducting agent. As the binding agent 16, besides the same binding agent as that used for the positive-electrode mixture, sodium polyacrylate or the like, for example, may be used. Carbon powder, for example, can also be used as the conducting agent. Only the hydrogen storage alloy particles 14 and the binding agent 16 are shown schematically within the circle in the FIGURE, while the negative-electrode substrate and conductive agent are omitted.

The hydrogen storage alloy particles 14 comprises a rare earth-Mg—Ni hydrogen storage alloy (rare earth-Mg—Ni hydrogen alloy), and has a Ce₂Ni₇-type crystal structure or a crystal structure similar to the Ce₂Ni₇-type, not a CaCu₅(AB₅)-type crystal structure. The Ce₂Ni₇-type is a super lattice structure which is an AB₅-type and AB₂-type combined.

As the rare earth-Mg—Ni hydrogen storage alloy with a crystal structure similar to an AB_{3.5}-type (Ce₂Ni₇-type), a rare earth-Mg—Ni hydrogen storage alloy with an AB_{3.8}-type (Ce₅Co₁₉-type), AB_{3.8}-type (Pr₅Co₁₉-type) or AB_{3.0}-type (PuNi₃-type) crystal structure can be used.

The composition of the rare earth-Mg—Ni hydrogen storage alloy that forms the hydrogen storage alloy particles 14 is expressed by a general formula (I):

(A_{α}Ln_{1-α})_{1-β}Mg_{β}Ni_{γ-δ-ε}Al_{δ}T_{ε}

wherein A represents one or more elements selected from the group consisting of Pr, Nd, Sm and Gd and including at least Sm, Ln represents at least one element selected from the group consisting of La, Ce, Pm, Eu, Tb, Dy, Ho, Er, Tm, Yb, Lu, Ca, Sr, Sc, Y, Ti, Zr and Hf, T represents at least one element selected from the group consisting of V, Nb, Ta, Cr, Mo, Mn, Fe, Co, Zn, Ga, Sn, In, Cu, Si, P and B, and subscripts α, β, γ, Δ and ε represent numerical values which respectively satisfy 0.4≦α, 0.05<β<0.15, 3.0≦γ≦4.2, 0.15≦δ≦0.30 and 0≦ε≦0.20.

The negative electrode 4 can be made, for example, by preparing a negative-electrode slurry by mixing and kneading the hydrogen storage alloy particles 14, the binding agent 16, and, as needed, the conducting agent, and then rolling and cutting a negative-electrode substrate having the prepared negative-electrode slurry applied and filled thereto after drying the negative-electrode slurry.

The hydrogen storage alloy particles 14 are obtained, for example, as follows.

First, metal materials are measured out so as to have a predetermined composition and mixed, and the mixture is melted, for example, in a high-frequency melting furnace to be formed into an ingot. The ingot obtained is subjected to a heat treatment in which the ingot is heated in an inert gas atmosphere at a temperature of 900 to 1200° C. for 5 to 24 hours to thereby change the metallographic structure of the ingot to a Ce₂Ni7-type crystal structure or a crystal structure similar thereto. Thereafter, the ingot is pulverized and the particles obtained are sieved to classify the particles into a desired particle size, yielding the hydrogen storage alloy particles 14.

In the foregoing nickel-hydrogen storage cell, a large amount of Al forms a solid solution in the parent phase of the rare earth-Mg—Ni hydrogen storage alloy forming the hydrogen storage alloy particles 14. This is because the rare earth-Mg—Ni hydrogen storage alloy contains Sm as its essential element, and the subscript α indicating the ratio of the content of the element represented by A is 0.40 or greater. The formation of a solid solution with a large amount of Al makes the crystal structure of the rare earth-Mg—Ni hydrogen storage alloy stable, and improves the corrosion resistance and oxidation resistance. As a result, the cycle-life characteristic of the nickel-hydrogen storage cell is improved.

In addition, as the subscript α is 0.40 or greater, the hydrogen equilibrium pressure of the rare earth-Mg—Ni hydrogen storage alloy is increased. This increases the operation voltage of the nickel-hydrogen storage cell, thus improving the discharge characteristic.

When a large amount of La, for example, is contained as Ln and the subscript α is less than 0.40, the hydrogen equilibrium pressure is reduced and the crystal structure of the rare earth-Mg—Ni hydrogen storage alloy is changed in accordance with the progress of the charge/discharge cycle, reducing the amount of hydrogen stored in or discharged from the rare earth-Mg—Ni hydrogen storage alloy, namely, the amount of the electrochemical capacitance. This decreases the ratio of the capacitance of the negative electrode to the capacitance of the positive electrode (capacitance ratio), and makes it easier to increase the internal pressure of the nickel-hydrogen storage cell, thus lowering the cycle characteristic.

When the subscript α is less than 0.40, a large amount of Al cannot form a solid solution in the parent phase of the rare earth-Mg—Ni hydrogen storage alloy, forming a segregation layer mainly containing Al, resulting in reduction in cycle characteristic and reduction in discharge characteristic.

It is to be noted that in the above-described nickel-hydrogen storage cell, setting the subscript β in the general formula (I) less than or equal to 0.15 prevents the precipitation of an undesired phase containing Mg as a major component, which, also in this respect, improves the cycle characteristic of the cell. That is, since the subscript β is less than or equal to 0.15, microparticulation of the hydrogen storage alloy powder originated from the charge/discharge cycle is suppressed, thus improving the cycle characteristic. As the subscript β is set greater than or equal to 0.05, the hydrogen storage alloy can store a large amount of hydrogen.

In the general formula (I), if the subscript y becomes too small, the storage stability of hydrogen stored in the hydrogen storage alloy increases, so that the hydrogen release capacity deteriorates, whereas if the subscript γ becomes too large, then the number of hydrogen storage sites in the hydrogen storage alloy decreases, so that the hydrogen storage capacity begins to deteriorate. Therefore, the subscript y is set to satisfy 3.0≦γ≦4.2, and preferably to satisfy 3.2≦γ≦3.8.

The following is the reason why in the general formula (I), the subscript δ indicating the substitute amount of Ni with Al is set to satisfy 0.15≦δ≦0.30. If the subscript δ is less than 0.15, the aforementioned effects of improving the cycle characteristic and discharge characteristic cannot be obtained sufficiently, whereas if the subscript δ exceeds 0.30, the precipitate having Al as a major component is produced, lowering the corrosion resistance and oxidation resistance of the rare earth-Mg—Ni hydrogen storage alloy, so that the cycle characteristic of the nickel-hydrogen storage cell is lowered.

Further, in the general formula (I), if the subscript ε indicating the substitute amount of Ni with the substitute element T becomes too large, the crystal structure of the hydrogen storage alloy changes, so that the hydrogen storage alloy begins to lose the hydrogen storage-release capacity. In addition, as microparticulation of the alloy progresses, the corrosion resistance is lowered. Therefore, the subscript ε is set to satisfy 0≦ε≦0.20.

### EXAMPLES

### 1. Preparation of Negative Electrode

Metal materials were measured out to have the compositions of Examples 1 to 7 and Comparative Examples 1 to 6 and mixed, and the mixtures were melted in a high-frequency melting furnace, yielding a plurality of ingots. Those ingots were heated in an argon atmosphere at the temperature of 1000° C. for 10 hours to thereby change the crystal structure of each ingot to a Ce₂Ni₇-type structure or a structure similar thereto. Thereafter, the individual ingots were mechanically pulverized in an inert atmosphere and sieved to thereby obtain powders of rare earth-Mg—Ni hydrogen storage alloy particles having the compositions in Table 1. The obtained powders had the average particle size of 50 μm corresponding to weight integral 50% measured using a laser diffraction-scattering particle-size distribution measurement device.

0.5 mass-part of sodium polyacrylate, 0.12 mass-part of carboxymethylcellulose and 1.0 mass-part (solid basis) of PTFE dispersion (dispersion medium: water, specific gravity 1.5, 60 mass % of solids), 1.0 mass-part of carbon black and 30 mass-parts of water were added to 100 mass-parts of each powder of the rare earth-Mg—Ni hydrogen storage alloy particles obtained, and the materials were mixed and kneaded to prepare a negative-electrode slurry. Then, a nickel punching sheet coated with the negative-electrode slurry was dried, and then rolled and cut to thereby prepare a negative electrode for size AA.

### 2. Preparation of Positive Electrode

Nickel hydroxide powder having particles entirely or partly covered with a cobalt compound was prepared, and 100 mass-parts of this nickel hydroxide powder was mixed with 40 mass % of HPC dispersion to thereby prepare a positive-electrode slurry. A nickel porous sheet coated and filled with this positive-electrode slurry was dried and then rolled and cut to thereby prepare a positive electrode.

### 3. Assembly of Nickel-Hydrogen Storage Cell

The negative electrode and positive electrode obtained were rolled up with a separator made of polypropylene fiber non-woven fabric, a thickness of 0.1 mm and a basis weight (weight per unit area) of 40 g/m² inserted therebetween, thereby forming an electrode assembly. After the electrode assembly obtained was put in an exterior can and a predetermined mounting process was performed, an alkaline electrolyte made of a 7N aqueous potassium hydroxide solution and a 1N aqueous lithium hydroxide solution was injected into the exterior can. Then, the opening end of the exterior can was sealed by using a cover plate, etc., so that a sealed cylindrical nickel-hydrogen storage cell with a rating capacity of 2500 mAh and size AA was assembled.

Then, an initial activation process was performed in which each cell assembled was charged with a charging current of 0.1 It in an environment of the temperature of 25° C. for 15 hours, and then discharged with a discharge current of 0.2 It up to the termination voltage of 1.0 V.

### 4. Evaluation of Cells

With regard to the nickel-hydrogen storage cells of Examples 1 to 7 and Comparative Examples 1 to 6 which had undergone the initial activation process, the following tests were conducted. It is to be noted that regarding the cell of Comparative Example 3, since the alkaline electrolyte was leaked in the initial activation process, the cycle characteristic and the discharge characteristic could not be measured.

### (1) Cycle Characteristic

For each cell, in an environment of the temperature of 25° C., the charge/discharge cycle consisting of dV-controlled charging with a charging current of 1.0 It, 60-minutes rest and discharging with a discharge current of 1.0 It up to the termination voltage of 1.0 V was repeated 300 times. The discharge capacities in the first and 300th cycles were measured to obtain the percentage (Q/P×100) of the discharge capacity (Q) in the 300th cycle to the discharge capacity (P) in the first cycle. The results are shown in Table 1.

### (2) Discharge Characteristic

In an environment of the temperature of 25° C., each cell was charged with a charging current of 1.0 It under dV control, and then, after a 60-minute rest, discharged with a discharge current of 1.0 It up to the termination voltage of 0.5 V. Further, each cell was likewise charged and left at rest, and then discharged with a discharge current of 3.0 It up to the termination voltage of 1.0 V. The discharge capacities at the time of discharging were measured to obtain the percentage (S/R×100) of the discharge capacity (S) in discharging with a discharge current of 3.0 It to the discharge capacity (R) in discharging with a discharge current of 1.0 It. The results are shown as the discharge characteristic in Table 1; the greater the value is, the more excellent the discharge characteristic is.

### (3) Crystal Structure

The hydrogen storage alloy particles were extracted from the nickel-hydrogen storage cell immediately after the initial activation and from the nickel-hydrogen storage cell after 300 cycles of charging/discharging carried out in the above-described cycle characteristic test, and subjected to XRD (X-ray diffractometry) measurement. The following are the measuring conditions.

### <Measuring Conditions>

Apparatus: parallel beam X-ray diffractometer (Rint-2200 system by Rigaku Corporation), X-ray source: Cu-Kα rays, tube voltage: 50 kV, tube current: 300 mA, scan speed: 1°/min, sample rotational speed of 60 rpm

A powder X-ray diffraction pattern was measured for each hydrogen storage alloy particle obtained, and θ-2θ measurement was carried out for a diffraction peak at which 2θ is around 33° where there was a large change in the cycle evaluation test. The results of the measurement of the diffraction peak is shown in Table 1 as the ratio of the full width at the half maximum (FWHM) of diffraction peak of the hydrogen storage alloy particles obtained from the nickel-hydrogen storage cell after 300 cycles of charging/discharging to the FWHM of the diffraction peak of the hydrogen storage alloy particles obtained from the nickel-hydrogen storage cell immediately after the initial activation (after 300 cycles/immediately after the initial activation).

TABLE 1

| | | | Evaluation | | |
|---|---|---|---|---|---|
| | Rare earth-Mg—Ni hydrogen storage alloy used for | | Cycle | Discharge | |
| | negative electrode | | character- | character- | FWHM |
| | Composition | Subscript α | istic (%) | istic (%) | ratio |
| Ex. 1 | (La_{0.20}Nd_{0.40}Sm_{0.40})_{0.90}Mg_{0.10}Ni_{3.20}Al_{0.22} | 0.8 | 95 | 75 | 1.56 |
| Ex. 2 | (La_{0.15}Ce_{0.05}Nd_{0.40}Sm_{0.40})_{0.90}Mg_{0.10}Ni_{3.20}Al_{0.22} | 0.8 | 92 | 78 | 1.88 |
| Ex. 3 | (La_{0.20}Pr_{0.10}Nd_{0.30}Sm_{0.28}Gd_{0.12})_{0.90}Mg_{0.10}Ni_{3.20}Al_{0.22} | 0.8 | 94 | 76 | 1.69 |
| Ex. 4 | (La_{0.40}Nd_{0.20}Sm_{0.40})_{0.90}Mg_{0.10}Ni_{3.20}Al_{0.22} | 0.6 | 93 | 73 | 2.00 |
| Ex. 5 | (La_{0.50}Sm_{0.50})_{0.90}Mg_{0.10}Ni_{3.20}Al_{0.22} | 0.5 | 91 | 71 | 2.19 |
| Ex. 6 | (La_{0.20}Nd_{0.40}Sm_{0.40})_{0.92}Mg_{0.08}Ni_{3.20}Al_{0.22} | 0.8 | 93 | 76 | 1.63 |
| Ex. 7 | (La_{0.20}Nd_{0.40}Sm_{0.40})_{0.90}Mg_{0.10}Ni_{3.20}Al_{0.27} | 0.8 | 95 | 73 | 1.38 |
| Com. Ex. 1 | (La_{0.70}Nd_{0.20}Sm_{0.10})_{0.90}Mg_{0.10}Ni_{3.20}Al_{0.22} | 0.3 | 45 | 50 | 3.75 |
| Com. Ex. 2 | (La_{0.50}Ce_{0.20}Nd_{0.20}Sm_{0.10})_{0.90}Mg_{0.10}Ni_{3.20}Al_{0.22} | 0.3 | 41 | 55 | 4.38 |
| Com. Ex. 3 | (La_{0.20}Nd_{0.40}Sm_{0.40})_{0.97}Mg_{0.03}Ni_{3.20}Al_{0.22} | 0.8 | — | — | — |
| Com. Ex. 4 | (La_{0.20}Nd_{0.40}Sm_{0.40})_{0.75}Mg_{0.25}Ni_{3.20}Al_{0.22} | 0.8 | 38 | 72 | 1.63 |
| Com. Ex. 5 | (La_{0.20}Nd_{0.40}Sm_{0.40})_{0.90}Mg_{0.10}Ni_{3.10}Al_{0.35} | 0.8 | 51 | 63 | 1.88 |
| Com. Ex. 6 | (La_{0.20}Nd_{0.40}Sm_{0.40})_{0.90}Mg_{0.10}Ni_{3.25}Al_{0.05} | 0.8 | 25 | 60 | 3.75 |

### (4) Evaluation Results

The following are clear from Table 1.
(i) Examples 1 and 2 using the rare earth-Mg—Ni hydrogen storage alloys having the compositions indicated by the general formula (I) are excellent over Comparative Examples 1 and 2 in both the cycle characteristic and discharge characteristic. Examples 1 and 2 have smaller FWHM ratio as compared with Comparative Examples 1 and 2, so that changes in the crystal structures of the rare earth-Mg—Ni hydrogen storage alloys are also suppressed before and after the cycle characteristic test in Examples 1 and 2.
(ii) Likewise, Example 3 using the rare earth-Mg—Ni hydrogen storage alloy containing Sm, Pr and Nd as elements represented by A in the general formula (I) is also excellent in both the cycle characteristic and discharge characteristic. Example 3 also has a smaller FWHM ration, so that a change in the crystal structure of the rare earth-Mg—Ni hydrogen storage alloy is suppressed before and after the cycle characteristic test.
(iii) Likewise, Examples 4 and 5 using the rare earth-Mg—Ni hydrogen storage alloys having a larger La content than Example 1 are also excellent in both the cycle characteristic and discharge characteristic. Examples 4 and 5 also have smaller FWHM ratio, and so that changes in the crystal structures of the rare earth-Mg—Ni hydrogen storage alloys are suppressed before and after the cycle characteristic test.
(iv) Likewise, Example 6 which has a smaller subscript β of Mg than Example 1 is also excellent in both the cycle characteristic and discharge characteristic. Example 6 also has a smaller FWHM ratio, so that a change in the crystal structure of the rare earth-Mg—Ni hydrogen storage alloy is suppressed before and after the cycle characteristic test.
(v) Likewise, Example 7 which has a larger subscript δ of Al than Example 1 is also excellent in both the cycle characteristic and discharge characteristic. Example 7 also has a particularly small FWHM ratio, so that a change in the crystal structure of the rare earth-Mg—Ni hydrogen storage alloy is particularly suppressed before and after the cycle characteristic test.
(vi) Comparative Examples 1 and 2 having lower cycle characteristics than those of Examples 1 to 7 are associated with the large FWHM ratio. A large FWHM ratio indicates a large change in the crystal structure (reduction in crystallinity) of the rare earth-Mg—Ni hydrogen storage alloy originated from the progress of the charging/discharging cycle, and the lowering of the cycle characteristic is originated from the reduction in the hydrogen storage capacity of the rare earth-Mg—Ni hydrogen storage alloy caused by the lowering of the crystallinity.

The reductions in the hydrogen storage capacities of the rare earth-Mg—Ni hydrogen storage alloys in Comparative Examples 1 and 2 are confirmed by obtaining the rare earth-Mg—Ni hydrogen storage alloy particles from the nickel-hydrogen storage cells after the cycle characteristic test, and measuring the PCT (Pressure Composition Temperature) for the particles.

Comparative Examples 1 and 2 having lower discharge characteristics than those of Examples 1 to 7 is originated from the low hydrogen equilibrium pressures of the rare earth-Mg—Ni hydrogen storage alloys used in Comparative Examples 1 and 2.

In view of the above, in comparison between Examples 1 to 7 and Comparative Examples 1 and 2, the subscript α in the general formula (I) is set greater or equal to 0.4.
(vii) Comparative Example 3 in which the subscript β of Mg is as small as 0.03 could not be realized as a cell. This seems to come from the insufficient hydrogen storage capacity of the rare earth-Mg—Ni hydrogen storage alloy.

While Comparative Example 4 in which the subscript β of Mg is 0.25 has a good discharge characteristic, it has the cycle characteristic notably reduced. This is considered to be because, in Comparative Example 4, as the microparticulation of the rare earth-Mg—Ni hydrogen storage alloy progressed, a fresh surface which appeared due to the microparticulation was corroded by contact with the alkaline electrolyte, thus degrading the rare earth-Mg—Ni hydrogen storage alloy.

In this respect, the subscript β of Mg is set in a range indicated by 0.05<β<0.25, preferably, in a range indicated by 0.07<β<0.14.
(viii) In Comparative Example 5 in which Al has a subscript δ of 0.35, the cycle characteristic is lowered. This is considered to be because the precipitation of Al which cannot form a solid solution in the parent phase of the rare earth-Mg—Ni hydrogen storage alloy has lowered the corrosion resistance and causes the progress of the microparticulation.

In Comparative Example 6 in which the subscript δ of Al is 0.05, the cycle characteristic is lowered notably. This is considered to be because when there is a small Al content, as the charging/discharging cycle progresses, the stability of the crystal structure of the rare earth-Mg—Ni hydrogen storage alloy is deteriorated, thus lowering the hydrogen storage capacity. Accordingly, the subscript δ of Al is set in a range indicated by 0.15≦δ≦0.30.

The present invention is not limited to the above-described one embodiment and Examples, and can be modified in various forms. Although the alkaline storage cell according to the one embodiment has a cylindrical shape, it may of course have a rectangular shape. The shape and size of the cell, the structure of the safety valve, the way of connecting between the electrodes and electrode terminals, etc. are not limited to those described above.

The invention thus described, it will be obvious that the same may be varied in many ways. Such variations are not to be regarded as a departure from the sprit and scope of the invention, and all such modifications as would be obvious to one skilled in the art are intended to be included within the scope of the following claims.

What is claimed is:

1. An alkaline storage cell comprising:
a positive electrode;
a separator;
an electrolyte; and
a negative electrode containing a rare earth-Mg—Ni hydrogen storage alloy, the rare earth-Mg—Ni hydrogen storage alloy having a composition expressed by a general formula:
(Al_{α}Ln_{1-α})_{1-β}Mg_{β}Ni_{γ-δ-ε}Al_{δ}T_{ε}
wherein A represents one or more elements selected from the group consisting of Pr, Nd, Sm and Gd and including at least Sm, Ln represents at least one element selected from the group consisting of La, Ce, Pm, Eu, Tb, Dy, Ho, Er, Tm, Yb, Lu, Ca, Sr, Sc, Y, Ti, Zr and Hf, T represents at least one element selected from the group consisting of V, Nb, Ta, Cr, Mo, Mn, Fe, Co, Zn, Ga, Sn, In, Cu, Si, P and B, and subscripts α, β, γ, δ and ε represent numerical values which respectively satisfy 0.4≦α, 0.05<β<0.15, 3.0≦γ≦4.2, 0.15≦δ≦0.30 and 0≦ε≦0.20.

2. The alkaline storage cell according to claim 1, wherein the subscript β is in a range indicated by 0.07≦β<0.14.

3. The alkaline storage cell according to claim 1, wherein the subscript γ is in a range indicated by 3.2≦γ≦3.8.
